(19) United States
(12) Patent Application Publication
(10) Pub. No.: US 2005/0092667 A1
(43) Pub. Date: May 5, 2005

(54) Filter

(76) Inventor: Rodney George Wade, Upper Coomera (AU)

Correspondence Address: NIXON & VANDERHYE, PC, 1100 N GLEBE ROAD, 8TH FLOOR, ARLINGTON, VA, 22201-4714, US

(21) Appl. No.: 10/698,517

(22) Filed: Nov. 3, 2003

(51) Int. Cl. B01D 29/00

(52) U.S. Cl. 210/163; 210/483

(57) ABSTRACT

A filter is disclosed having a base wall and at least one side wall made from metal mesh material. The side wall consisting of wall portions forming integral extensions to the base wall. Ribs of plastic material are moulded against the mesh material to connect edges of adjacent side wall portions to one another.

### BACKGROUND OF THE INVENTION

This invention relates to a filter. In particular the invention relates to a filter adapted to be used with a first flush water diverter.

The invention will be described by way of example with reference to its use with a first flush water diverter. However, it should be appreciated that the filter may be employed with other water catchment fittings and components.

Water diverters are located in the water flow path between a catchment area such as the roof of a building and a water storage tank. The primary purpose of water diverters is to ensure that when it begins to rain the first flow of water from the catchment area is diverted away from the tank and after the roof, gutters and downpipes are flushed, water is then directed to the storage tank.

There are a myriad of various types of undesirable particles of rubbish that ends up on the roof, ranging from insects, lizards, frogs and vegetable matter and animal droppings. If these particles are not diverted they will end up in the storage tank.

A variety of means are employed in an attempt at screening these undesirable particles from the water collected in the tank. These include gutter guards or screens, filter pits located downstream of the downpipes and upstream of the water diverter and inlet screens across the water inlet into the storage tank.

Water diverters are not intended to be rubbish diverters although most will accept a degree of debris and still function adequately.

Some diverters incorporate a screen or filter able to exclude particles down to 955 micron in size. These screens or filters are located at an upper end of the diverter and filter the water as it enters the diverter. These filters ensure that debris is excluded from the diverter so that its function is not compromised. In addition, these filters ensure that water ultimately directed to the storage tank is kept relatively free of contaminants.

Poor filter design may result in ineffective filtering or clogging of the filter. Filter clogging requires constant filter cleaning and maintenance otherwise water may be prevented from entering the storage tank and be lost and cause damage or flooding.

Poor filter design also led to unnecessary restriction in the flow of water and in extreme cases the presence of a filter at the diverter inlet may lead to overflow of water and water, otherwise available for storage, was lost.

### OBJECT OF THE INVENTION

It is an object of the invention to provide a filter for use with a first flush water diverter which at least minimises the disadvantages mentioned above.

### SUMMARY OF THE INVENTION

According to one aspect, the invention provides a filter having a base wall and at least one side wall made from a metal mesh material, the side wall consisting of wall portions forming integral extensions to the base wall, ribs of plastic material moulded against the mesh material connect edges of adjacent said side wall portions to one another.

The base wall may have any suitable shape. For example, the base wall may be square, rectangular or round. Preferably, the base wall is circular in shape.

Where the base wall is square or rectangular, the wall portions may also be square or rectangular. When the filter is constructed utilising a flat mesh material, the wall portions may form planar extensions to the base wall. If the wall portions are rectangular or square and are folded relative to the base wall to extend upwardly therefrom so that edges of adjacent wall portions may be connected relative to one another by plastic material moulded thereto, the wall portions will extend at right angles to the base wall. The wall portions may be trapezoidal in shape and when the side wall portions are folded relative to the base wall to allow edges of adjacent side wall portions to be connected to one another by plastic material moulded thereto, a filter with upwardly and outwardly inclined side walls may be produced.

When the base wall is circular in shape, the side wall portions may form a continuous side wall. The side wall may extend at right angles to the base wall. Preferably the wall portions are configured so that they form a upwardly extending and outwardly inclined side wall.

The plastic material, as mentioned, is moulded to the mesh material to encapsulate edges of the side wall portions to not only connect adjacent side wall portions to one another but to also form strengthening ribs extending upwardly along the side wall.

Preferably, the plastic material is moulded to the mesh material to form strengthening ribs extending across the base wall. Where the base wall is circular in shape, the strengthening ribs may extend diametrically across the base wall.

Preferably, the plastic material is moulded to form a rim extending around an upper edge of the resultant filter. The rim may consist of a lip and a short downwardly extending skirt. The lower edge of the skirt may encapsulate upper free edges of the side wall portions.

Openings may be formed in the lip to allow the filter to be mounted in position relative to, for example, a diverter (not shown). The openings may be keyhole openings circumferentially spaced around the lip.

### DESCRIPTION OF THE DRAWINGS

A preferred embodiment of the invention will now be described by way of example with reference to the drawings in which:

FIG. 1 is a perspective view of a filter according to an embodiment of the invention;

FIG. 1a is a detailed view of a portion of the filter of FIG. 1;

FIG. 2 is a plan view of the filter of FIG. 1;

FIG. 2a is a detailed elevational view of a portion of the filter of FIG. 2; and,

FIG. 3 is a plan view of metal mesh material employed in the filter of FIG. 1.

### DETAILED DESCRIPTION OF THE PREFERRED EMBODIMENT

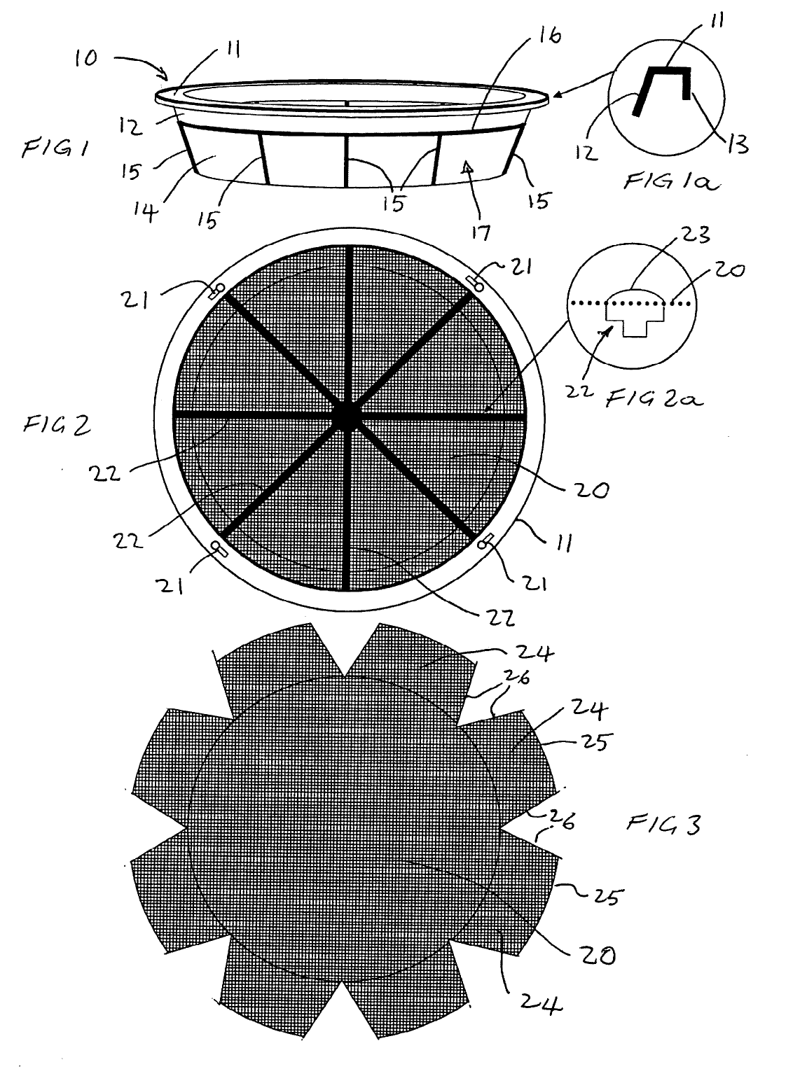

FIG. 1 shows a perspective view of a filter 10. The filter has a lip 11 with a downwardly extending skirt 12. As shown in FIG. 1a an outer edge of the lip has a downwardly extending flange 13.

The filter has a continuous side wall 14 made of metal mesh material. Plastic material is moulded to the mesh material to encapsulate portions of the side wall 17 within it to form ribs 15 extending up the side wall at locations around the side wall. These ribs 15 not only strengthen the side wall but also encapsulate a portion of the mesh material. A circular rib 16 may extend around the wall 17 at an upper extremity of the mesh material where it is captured by the skirt 12.

The filter 10 has a base wall 20 and the side wall 17 is integral with the base wall 20. The lip 11 is provided with circumferentially spaced keyhole openings 21. Openings 21 may receive upstanding fasteners extending from an upper edge of a diverter. These fasteners may have an enlarged head adapted to fit through the enlargement of the keyhole openings 21. The filter may be rotated to lock it into place relative to the diverter and to the fasteners extending from it.

Plastic material is moulded relative to the mesh material to form the lip 11 and ribs 15, 16. This plastic material may also form strengthening ribs 22 extending across the base wall 20 of the filter. The ribs 15 may form extensions to the ribs 22.

FIG. 2a shows detail of how the mesh material which forms the base and side walls of the filter is encapsulated in plastic material to firm a rib 22. The ribs 15 may have a similar cross section to the rib 22 shown in detail in FIG. 2a. The rib 22 has a contoured upper surface 23 for directing water from it and onto the mesh material of the base wall 20.

FIG. 3 shows the metal mesh material employed in the filter 10. Preferably stainless steel mesh is used. It is preferred that the mesh aperture is 955 micron although other sizes are not excluded. The material has a base wall 20 and side wall portions 24. The side wall portions have an outer edge 25 and side edges 26. When the mesh material is folded so that side edges 26 of adjacent side wall portions 24 are closely adjacent one another a tray having a circular base wall 20 with a upwardly and outwardly extending side wall 14 is formed.

The plastic material moulded to the mesh material provides the lip 11, forms the ribs 15 which encapsulate free edges 26 of adjacent portions 24, forms rib 16 which encapsulates edges 25 of the portions 24 and forms the ribs 22 which strengthen the base wall 20.

The filter of the invention provides for relatively unobstructed water flow through it. By having a side wall with filter apertures the effective filter area is increased.

1. A filter having a base wall and at least one side wall made from metal mesh material, the side wall consisting of wall portions forming integral extensions to the base wall, ribs of plastic material moulded against the mesh material connect edges of adjacent said side wall portions to one another.

2. The filter of claim 1 wherein the side wall extends upwardly at an inclined angle relative to the base wall.

3. The filter of claim 1 wherein the metal mesh material is made of stainless steel having apertures of about 955 micron.

4. The filter of claim 1 wherein the base wall is circular in shape.

5. The filter of claim 4 wherein strengthening ribs are moulded to the base wall to encapsulate portions of the mesh material.

6. The filter of claim 5 wherein the strengthening ribs in the base wall merge into the ribs in the side wall.

7. The filter of claim 6 wherein the strengthening ribs extend diametrically across the base wall.

8. The filter of claim 1 including a rim extending around an upper edge of the filter.

9. The filter of claim 8 wherein the rim consists of a lip with a downwardly extending skirt with the lower edge of the skirt encapsulating upper free edges of the side wall portions.

10. The filter of claim 9 wherein a flange extends downwardly from a free edge of the lip.

11. The filter of claim 9 wherein the lip has spaced fixing apertures.
